(19) United States
(12) Patent Application Publication
(10) Pub. No.: US 2018/0340501 A1
(43) Pub. Date: Nov. 29, 2018

(54) VARIABLE DISPLACEMENT FUEL PUMP WITH POSITION SENSOR

(71) Applicants: Weishun Willaim Ni, Rockton, IL (US); Edward W. Goy, Crystal Lake, IL (US); David Lauriat, DeKalb, IL (US); Dennis L. Kaderabek, Caledonia, IL (US); Dennis A. Erickson, Rockton, IL (US)

(72) Inventors: Weishun Willaim Ni, Rockton, IL (US); Edward W. Goy, Crystal Lake, IL (US); David Lauriat, DeKalb, IL (US); Dennis L. Kaderabek, Caledonia, IL (US); Dennis A. Erickson, Rockton, IL (US)

(21) Appl. No.: 15/602,385

(22) Filed: May 23, 2017

(51) Int. Cl. F02M 59/04; F04B 1/20; F04B 1/30; F02M 59/28; F02D 41/30

(52) U.S. Cl. CPC F02M 59/04; F04B 1/2035; F02D 41/3082; F04B 1/30; F02M 59/28; F04B 1/2064

(57) ABSTRACT

A variable displacement fuel pump includes a pump body, a barrel disposed within the pump body, at least one piston disposed in the barrel, wherein the at least one piston is configured to reciprocate within the barrel, a hydraulic actuator operatively coupled to the barrel, wherein the hydraulic actuator rotates the barrel to a selected barrel angle relative to the at least one piston, and a position sensor operatively coupled to the hydraulic actuator to provide an actuator position parameter.

### BACKGROUND

The subject matter disclosed herein relates to fuel pumps, and more particularly, to variable displacement fuel pumps with position sensors.

High pressure fuel systems are typically used in a variety of applications to provide fuel flow and pressure sufficient to engines during various levels of demand. Fuel systems often designed to provide excess fuel flow to ensure fuel demands are met during all operation conditions. Often, excess fuel flow can waste energy and cause extra fuel heating. Further, fuel systems must provide sufficient fuel during acceleration. During acceleration fuel must be furnished to the turbine exceeding steady state requirements. However, if the fuel flow increases too rapidly, a rich mixture may cause a surge.

In more detail, such systems typically operate such that unused fuel is recirculated continuously. The recirculation can be achieved by a bypass valve and a high pressure fixed displacement fuel pump but the valve and pump lead to the fuel heating described above. Further, the fixed displacement pump is typically oversized to provide design margin for end of life then the excess fuel capacity and this leads to the recirculation of large amounts of pressurized fuel. As the fuel is returned and recirculated, the pressure drops and heat is generated.

### BRIEF SUMMARY

According to an embodiment, a variable displacement fuel pump includes a pump body, a barrel disposed within the pump body, at least one piston disposed in the barrel, wherein the at least one piston is configured to reciprocate within the barrel, a hydraulic actuator operatively coupled to the barrel, wherein the hydraulic actuator rotates the barrel to a selected barrel angle relative to the at least one piston, and a position sensor operatively coupled to the hydraulic actuator to provide an actuator position parameter.

According to an embodiment, a fuel system includes a fuel source, a variable displacement fuel pump, including a pump body, a barrel disposed within the pump body, at least one piston disposed in the barrel, wherein the at least one piston is configured to reciprocate within the barrel to provide a fuel flow, a hydraulic actuator operatively coupled to the barrel, wherein the hydraulic actuator rotates the barrel to a selected barrel angle relative to the at least one piston, and a position sensor operatively coupled to the hydraulic actuator to provide an actuator position parameter, a controller to receive a thrust demand parameter and the actuator position parameter to provide a hydraulic pressure to the hydraulic actuator corresponding to a fuel flow, and a thrust output device to receive the fuel flow to provide a thrust output corresponding to the thrust demand parameter.

According to an embodiment, a method to provide a desired thrust output corresponding to a thrust demand parameter includes providing an actuator position parameter of a hydraulic actuator to the controller via a position sensor, receiving the thrust demand parameter and the actuator position parameter via a controller, providing a hydraulic pressure via the controller, providing a fuel flow via a variable displacement fuel pump, including: a pump body, a barrel disposed within the pump body, and at least one piston disposed in the barrel, wherein the at least one piston is configured to reciprocate within the barrel to provide the fuel flow, and rotating the barrel of the variable displacement fuel pump to a selected barrel angle relative to the at least one piston in response to the desired fuel flow parameter via the hydraulic pressure applied to a hydraulic actuator.

Technical function of the embodiments described above includes a position sensor operatively coupled to the hydraulic actuator to provide an actuator position parameter.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1 is a schematic view of an embodiment of a fuel system; and

FIG. 2 is a partial cross sectional view of an embodiment of a variable displacement pump for use with the fuel system of FIG. 1.

### DETAILED DESCRIPTION

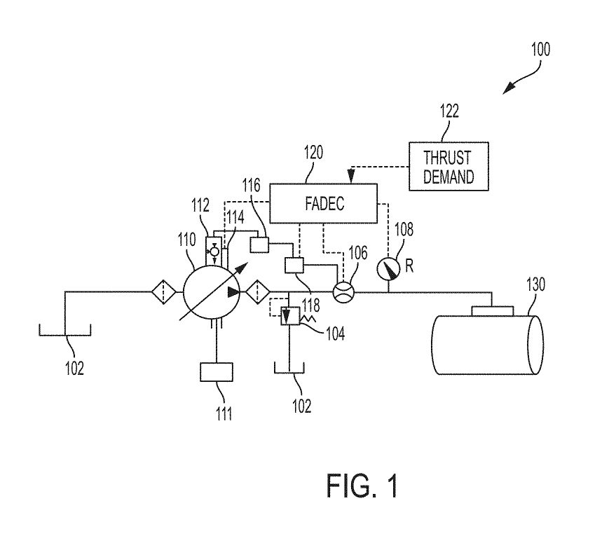

Referring to the drawings, FIG. 1 shows a fuel system 100 according to one embodiment. In the illustrated embodiment, the fuel system 100 includes a fuel source 102, a variable displacement pump 110, a high pressure relief valve 104, a fuel mass flow metering sensor 106, a fuel flow pressure sensor 108, a full authority digital engine control (FADEC) 120, and a thrust output device 130. In the illustrated embodiment, the fuel system 100 provides a fuel flow from the fuel source 102 to the thrust output device 130 at a desired fuel flow rate to provide a desired thrust indicated by an operator.

The fuel source 102 can include fuel tanks or other portions of the fuel system 100 not shown. In the illustrated embodiment, the fuel source 102 can provide fuel to the variable displacement pump 110. In certain embodiments, excess or relief fuel flow from the variable displacement pump 110 can be redirected to the fuel source 102 via the high pressure relief valve 104.

In the illustrated embodiment, the thrust output device 130 is any suitable thrust output device, including, but not limited to, a gas turbine engine. Gas turbine engine thrust output is primarily controlled by the amount of fuel supplied to the engine combustion chamber via the engine nozzles. Therefore, the thrust output of the gas turbine engine or any suitable thrust output device 130 is based on the amount of fuel supplied to the thrust output device 130. During flight operations, thrust demands can change rapidly, requiring rapid changes in fuel flow. In certain embodiments, thrust demands can be independent from engine operation speed.

In the illustrated embodiment, a variable displacement pump 110 can provide a desired fuel flow to the thrust output device 130 without excess fuel being returned to the fuel source 102. In the illustrated embodiment, the variable displacement pump 110 is driven by a pump drive 111. The pump drive 111 can be provided by an engine or any other suitable source, including the thrust output device 130. In the illustrated embodiment, the variable displacement pump 110 includes a hydraulic actuator 112 to control the displacement of the variable displacement pump 110 to provide a desired fuel flow rate independent of the pump drive 111 speed in response to the thrust demand 122 received by the FADEC 120.

In the illustrated embodiment, the hydraulic actuator 112 can receive hydraulic pressure to change the displacement and output of the variable displacement pump 110. In certain embodiments, the hydraulic actuator 112 can be actuated by fuel pressure. In certain embodiments, fuel pressure is provided by the variable displacement pump 110 and further can be directed to the hydraulic actuator 112 from the output of the pump 110 via the fuel mass flow metering sensor 106.

In the illustrated embodiment, hydraulic pressure to the hydraulic actuator 112 is selectively provided by an electrohydraulic servo valve (EHSV) 118 and a compensator 116. In the illustrated embodiment, the EHSV 118 is an electrically operated valve that controls the pressure and flow of hydraulic fluid that is provided to the hydraulic actuator 112. The EHSV 118 can provide control of the hydraulic pressure applied to the hydraulic actuator 112 and therefore the displacement of the variable displacement pump 110. Operation of the EHSV 118 can be controlled by the FADEC 120 in response to the thrust demand 122 and the position of the hydraulic actuator 112. In the illustrated embodiment, the compensator 116 can maintain a desired pressure differential as the flow rate directed to the hydraulic actuator 112 changes.

In the illustrated embodiment, the position of the hydraulic actuator 112 can be measured by a position sensor 114. The position sensor 114 can provide feedback to the FADEC 120 regarding the hydraulic actuator 112 position to allow for closed loop control of the output of the variable displacement pump 110.

In the illustrated embodiment, the fuel mass flow metering sensor 106 can selectively restrict fuel flow from the variable displacement pump 110 to the thrust output device 130. In the illustrated embodiment, the fuel mass flow metering sensor 106 can provide fine control and transient control of fuel flow to the thrust output device 130. In the illustrated embodiment, as the fuel mass flow metering sensor 106 restricts fuel flow there through, any excess pressure can be relieved by the high pressure relief valve 104 to be released back into the fuel source 102. The high pressure relief valve 104 can prevent fuel pressure from exceeding a desired pressure. The operation of the fuel mass flow metering sensor 106 can be controlled by the FADEC 120 in response to the thrust demand 122 and the fuel flow pressure sensor 108.

In the illustrated embodiment, the FADEC 120 can receive parameters regarding flight operation and control various aspects of the fuel system 100, including the variable displacement pump 110. In the illustrated embodiment, the FADEC 120 can receive a thrust demand parameter 122 from an operator. In certain embodiments, the thrust demand parameter 122 can be calculated by other flight systems. Further, in the illustrated embodiment, the FADEC 120 can receive information regarding the fuel flow and fuel pressure received by the thrust output device 130 via a fuel flow pressure sensor 108. In the illustrated embodiment, the fuel flow pressure 108 measures one or more of fuel flow and pressure and provides these parameters to the FADEC 120. In the illustrated embodiment, the FADEC 120 receives information regarding the position of the hydraulic actuator 112 via the position sensor 114.

In response to the measured parameters from the fuel flow pressure sensor 108, the position sensor 114, and the thrust demand parameter 122, the FADEC 120 can adjust the fuel mass flow metering sensor 106 and the variable displacement pump 110 to provide a desired fuel flow to the thrust output device 130. In the illustrated embodiment, the FADEC 120 can adjust the output of the variable displacement pump 110 by adjusting the hydraulic pressure provided to the hydraulic actuator 112 by controlling the EHSV 118. In certain applications, the FADEC 120 can govern the desired fuel flow to the thrust output device 130 by precisely controlling the output of the variable displacement pump 110. In the illustrated embodiment, the FADEC 120 can minimize flow restriction of the fuel mass flow metering sensor106 to prevent excess return or bypass of fuel flow to the fuel source 102 via the high pressure relief valve 104. In certain embodiments, the fuel mass flow metering sensor 106 may be utilized for fine and transient adjustments of fuel flow to the thrust output device 130.

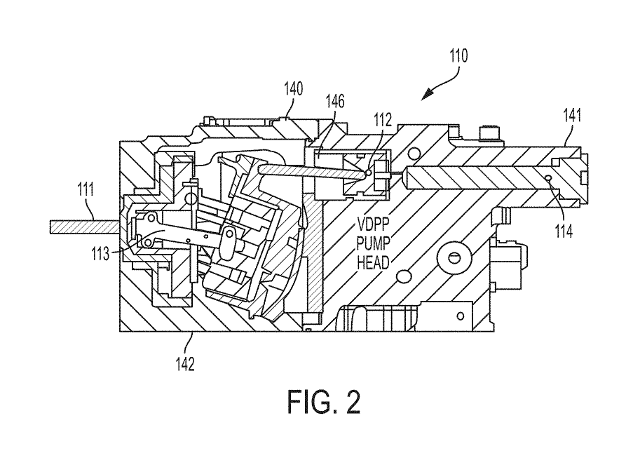

Referring to FIG. 2, an example variable displacement pump 110 is shown. In the illustrated embodiment, the variable displacement pump 110 includes the hydraulic actuator 112, the position sensor 114, an actuator rod 146, a pump body 140, a pump head 141, pistons 142, and a barrel 148. In the illustrated embodiment, a variable displacement pump 110 can vary the displacement or the amount of fluid pumped per revolution of the pump drive 111 while the variable displacement pump 110 is running. In the illustrated embodiment, the variable displacement pump 110 is an axial piston pump. In the illustrated embodiment, the control actuator 112 can tilt or rotate the barrel 148 relative to the pistons 142 to control the output of the variable displacement pump 110 independent of the input provided by the pump drive 111. Advantageously, the use of a variable displacement pump 110 allows for high efficiency at various flow requirements.

In the illustrated embodiment, the pistons 142 reciprocate within the barrel 148. The pistons 142 are powered by the pump drive 111. In the illustrated embodiment, the pistons 142 are disposed in cylinders arranged parallel to each other and rotating around a central shaft 113 powered by the pump drive 111. In the illustrated embodiment, the variable displacement pump 110 can include any suitable any number of pistons 142. In the illustrated embodiment, the variable displacement pump 110 includes 9 pistons.

In the illustrated embodiment, the barrel 148 can tilt or rotate with the pistons 142. The angle of the barrel 148 can change the stroke of the pistons 142. The angle between the barrel 148 and the pump drive 111 can be described as angle theta. In the illustrated embodiment, the variable displacement pump 110 is a swash plate axis pump, wherein the barrel 148 provides a maximum displacement capacity when the angle theta is maximized, while the variable displacement pump 110 provides 0 or minimum pumping capacity when the angle theta is zero or inline.

In the illustrated embodiment, the hydraulic actuator 112 and the position sensor 114 can be disposed within the pump head 141. In the illustrated embodiment, the hydraulic actuator 112 is coupled to the barrel 148 via an actuator rod 146. The hydraulic actuator 112 can adjust the angle theta of the barrel 148 to vary the displacement of the variable displacement pump 110.

In the illustrated embodiment, the hydraulic actuator 112 has a position sensor 114 to provide position feedback to the FADEC 120 to allow for closed loop control of the variable displacement pump 110. In the illustrated embodiment, the position sensor 114 can allow for accurate and rapid control of the variable displacement pump 110. The position sensor 114 can be a linear variable differential transformer (LVDT). In the illustrated embodiment, the position sensor 114 translates the rectilinear motion of the hydraulic actuator 112 to a corresponding electrical signal or parameter to be provided to the FADEC 120. In the illustrated embodiment, the position information from the position sensor 114 can be used to relate the position of the hydraulic actuator 112 to the barrel 148 tilting angle theta of the variable displacement pump 110. Therefore, position information from the position sensor 114 can be used to relate the position of the hydraulic actuator 112 to the fuel flow output of the variable displacement pump 110 for a given pump drive 111 speed.

Further, position information from the position sensor 114 can provide closed loop feedback regarding the hydraulic control of the hydraulic actuator 112. In the illustrated embodiment, the position sensor 114 can be utilized to relate the position of the hydraulic actuator 112 to the state of the EHSV 118 to account for any pressure drops within the hydraulic system, including but not limited to, the EHSV 118 and the compensator 116. Therefore, in certain embodiments, the FADEC 120 can determine the relationship between hydraulic pressure applied to the hydraulic actuator 112 via the EHSV 118 and the desired fuel flow rate to improve transient response.

Advantageously, by utilizing the variable displacement pump 110 with the hydraulic actuator 112, a desired fuel flow can be provided with minimal excess fuel flow being directed back to the fuel source 102. By maintaining a desired fuel flow rate, excess heating of fuel is minimized, minimizing fuel contamination and allowing for greater reliability. Further, improved transient response due to the position sensor 114 can prevent lean die-out or rich blow out conditions by allowing improved fuel flow control in transient applications.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A variable displacement fuel pump, comprising:
a pump body;
a barrel disposed within the pump body;
at least one piston disposed in the barrel, wherein the at least one piston is configured to reciprocate within the barrel;
a hydraulic actuator operatively coupled to the barrel, wherein the hydraulic actuator rotates the barrel to a selected barrel angle relative to the at least one piston; and
a position sensor operatively coupled to the hydraulic actuator to provide an actuator position parameter.

2. The variable displacement fuel pump of claim 1, wherein the position sensor is a linear variable differential transformer.

3. A fuel system, comprising:
a fuel source;
a variable displacement fuel pump, including:
a pump body;
a barrel disposed within the pump body;
at least one piston disposed in the barrel, wherein the at least one piston is configured to reciprocate within the barrel to provide a fuel flow;
a hydraulic actuator operatively coupled to the barrel, wherein the hydraulic actuator rotates the barrel to a selected barrel angle relative to the at least one piston; and
a position sensor operatively coupled to the hydraulic actuator to provide an actuator position parameter;
a controller to receive a thrust demand parameter and the actuator position parameter to provide a hydraulic pressure to the hydraulic actuator corresponding to a fuel flow; and
a thrust output device to receive the fuel flow to provide a thrust output corresponding to the thrust demand parameter.

4. The fuel system of claim 3, wherein the position sensor is a linear variable differential transformer.

5. The fuel system of claim 3, wherein the hydraulic pressure is a fuel hydraulic pressure.

6. The fuel system of claim 3, further comprising an electrohydraulic servo valve to provide the hydraulic pressure to the hydraulic actuator.

7. The fuel system of claim 3, further comprising a compensator in fluid communication with the hydraulic actuator.

8. The fuel system of claim 3, further comprising a high pressure relief valve to selectively direct the fuel flow to the fuel source.

9. The fuel system of claim 3, further comprising a fuel mass flow metering sensor to control the fuel flow to the thrust output device.

10. The fuel system of claim 3, further comprising a fuel flow pressure sensor to provide a measured fuel flow parameter to the controller.

11. A method to provide a desired thrust output corresponding to a thrust demand parameter, the method comprising:
providing an actuator position parameter of a hydraulic actuator to the controller via a position sensor;
receiving the thrust demand parameter and the actuator position parameter via a controller;
providing a hydraulic pressure via the controller;
providing a fuel flow via a variable displacement fuel pump, including:
a pump body;
a barrel disposed within the pump body; and
at least one piston disposed in the barrel, wherein the at least one piston is configured to reciprocate within the barrel to provide the fuel flow; and
rotating the barrel of the variable displacement fuel pump to a selected barrel angle relative to the at least one piston in response to the desired fuel flow parameter via the hydraulic pressure applied to a hydraulic actuator.

12. The method of claim 11, wherein the position sensor is a linear variable differential transformer.

13. The method of claim 11, wherein the hydraulic pressure is a fuel hydraulic pressure.

14. The method of claim 11, further comprising providing the hydraulic pressure to the hydraulic actuator via an electrohydraulic servo valve.

15. The method of claim 11, wherein a compensator is in fluid communication with the hydraulic actuator.

16. The method of claim 11, further comprising selectively directing the fuel flow to a fuel source via a high pressure relief valve.

17. The method of claim 11, further comprising controlling the fuel flow to the thrust output device via a fuel mass flow metering sensor.

18. The method of claim 11, further comprising providing a measured fuel flow parameter to the controller via a fuel flow pressure sensor.
